(19) United States
(12) Patent Application Publication
(10) Pub. No.: US 2026/0017666 A1
(43) Pub. Date: Jan. 15, 2026

(54) CONTROL DEVICE CONFIGURED TO MANAGE WARRANTY PERIOD INFORMATION

(71) Applicant: BROTHER KOGYO KABUSHIKI KAISHA, Nagoya (JP)

(72) Inventor: Hironori TAKASAKI, Ogaki (JP)

(73) Assignee: BROTHER KOGYO KABUSHIKI KAISHA, Nagoya (JP)

(21) Appl. No.: 19/230,813

(22) Filed: Jun. 6, 2025

(30) Foreign Application Priority Data
Jul. 10, 2024 (JP) 2024-110986

(51) Int. Cl. G06Q 30/012

(52) U.S. Cl. CPC G06Q 30/012

(57) ABSTRACT

A consumable component consuming device includes an input unit configured to receive user input, a display unit, a storage unit, and a controller. The controller causes the display unit to display an input screen that prompts the user to input a warranty period associated with a first warranty contract. Based on the input received via the input unit, the controller stores warranty period information corresponding to the warranty period of the first warranty contract in the storage unit.

### REFERENCE TO RELATED APPLICATIONS

This application claims priority from Japanese Patent Application No. 2024-110986 filed on Jul. 10, 2024. The entire content of the priority application is incorporated herein by reference.

### BACKGROUND

The present disclosure relates to a control device.

There is known an image forming device in which a warranty period for each of consumable components, such as conveyance rollers, is stored in a memory in advance. When a defect (error) occurs in a consumable component during the warranty period, the user is notified of warranty period that includes a stepwise reduction in the cost of replacement, repair, or maintenance associated with the error.

### SUMMARY

In conventional image forming device as mentioned above, the warranty period is typically pre-stored in a memory. For example, the warranty period may be written into memory at the time the image forming device is shipped. However, in cases where the warranty period is determined based on the date of purchase by the user at a retail store, it may not be possible to pre-store the warranty period in the memory. In such cases, the device is unable to perform notifications or guidance based on the warranty status, and there is a possibility that the user may not receive appropriate warranty support.

According to aspects of the present disclosure, there is provided a control device configured to manage warranty period information. The control device includes an input unit configured to allow a user to input information, a display unit, a storage unit, and a controller. The controller is configured to cause the display unit to display an input screen for receiving input, via the input unit, of a warranty period associated with a first warranty contract, and to store, in the storage unit, warranty period information corresponding to the warranty period of the first warranty contract based on the input received via the input unit.

According to aspects of the present disclosure, the control device displays an input screen on a display unit to allow entry of a warranty period for a first warranty contract. Based on the input received through the input unit, the warranty period information for the first warranty contract is stored in a storage unit. For example, although the user may remember the warranty period at the time of purchasing the control device, this information may be forgotten over time. In such cases, the user might fail to receive appropriate warranty coverage even if the warranty period is still valid. By storing the warranty period information in the storage unit while the user still remembers it, such as shortly after purchase, the system can later provide notifications or guidance based on the stored warranty period information. This helps ensure that the user is more likely to receive appropriate warranty support when needed.

### BRIEF DESCRIPTION OF DRAWGINS

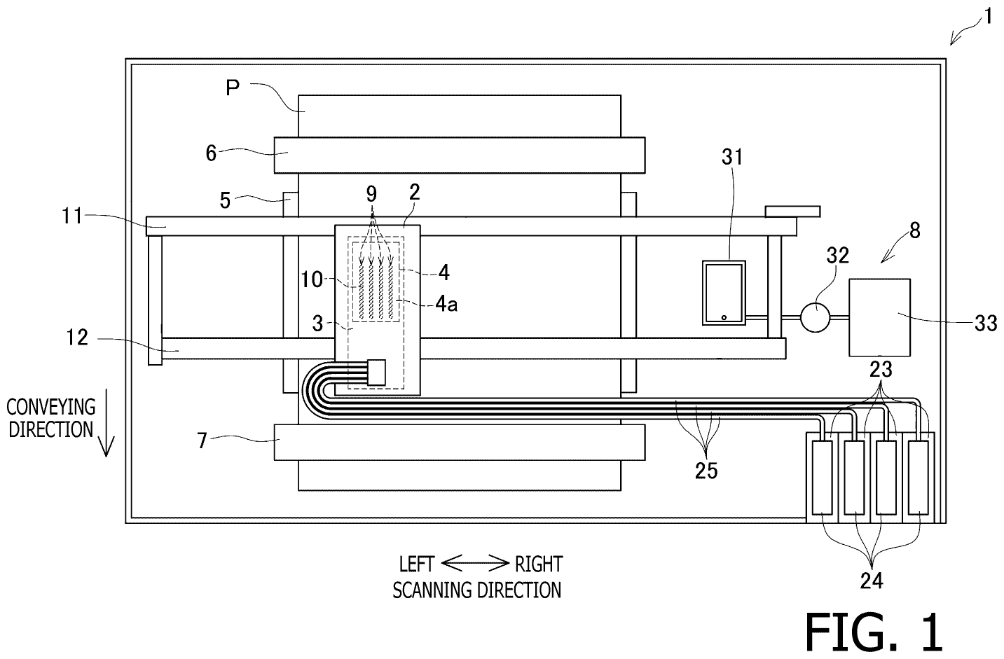

FIG. 1 is a schematic diagram illustrating the overall configuration of a printer.

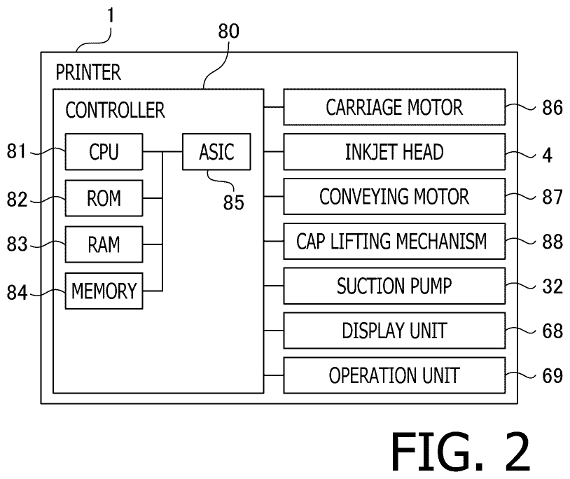

FIG. 2 is a block diagram showing the electrical configuration of the printer.

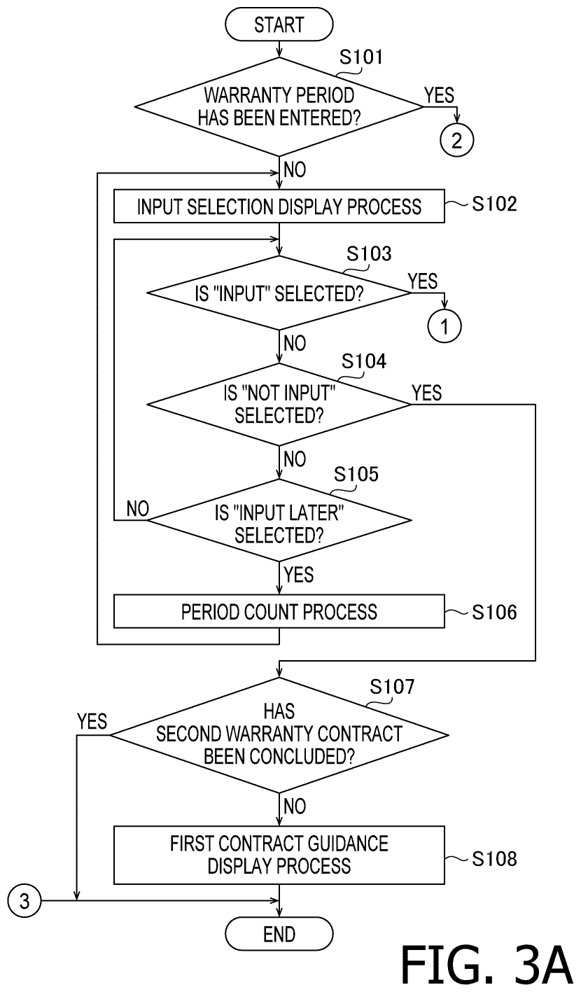

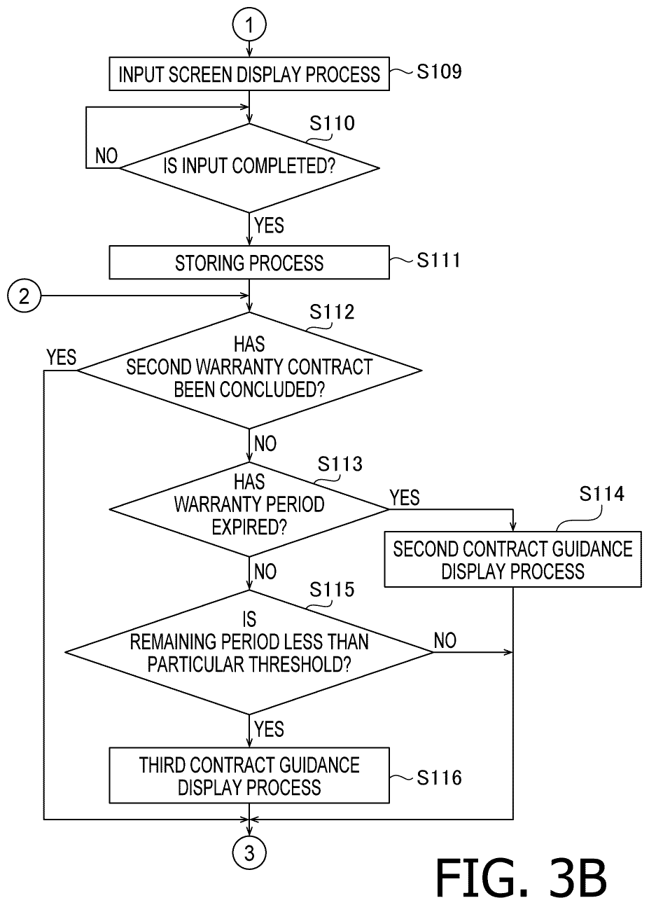

FIGS. 3A and 3B show a flowchart illustrating a processing flow for displaying an input screen and the like.

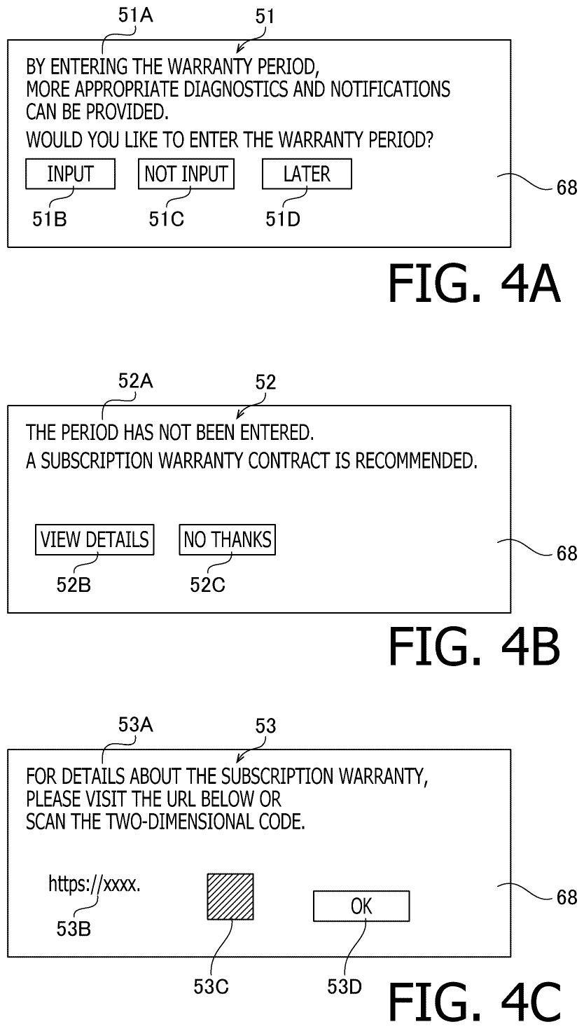

FIG. 4A illustrates a selection input screen.

FIG. 4B illustrates a first contract guidance screen.

FIG. 4C illustrates a detail screen.

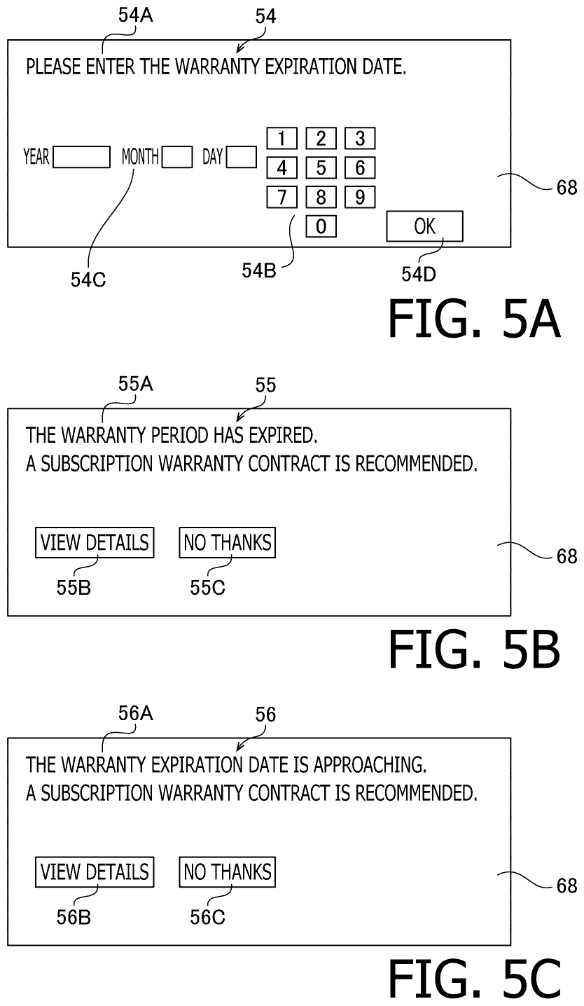

FIG. 5A illustrates an input screen.

FIG. 5B illustrates a second contract guidance screen.

FIG. 5C illustrates a third contract guidance screen.

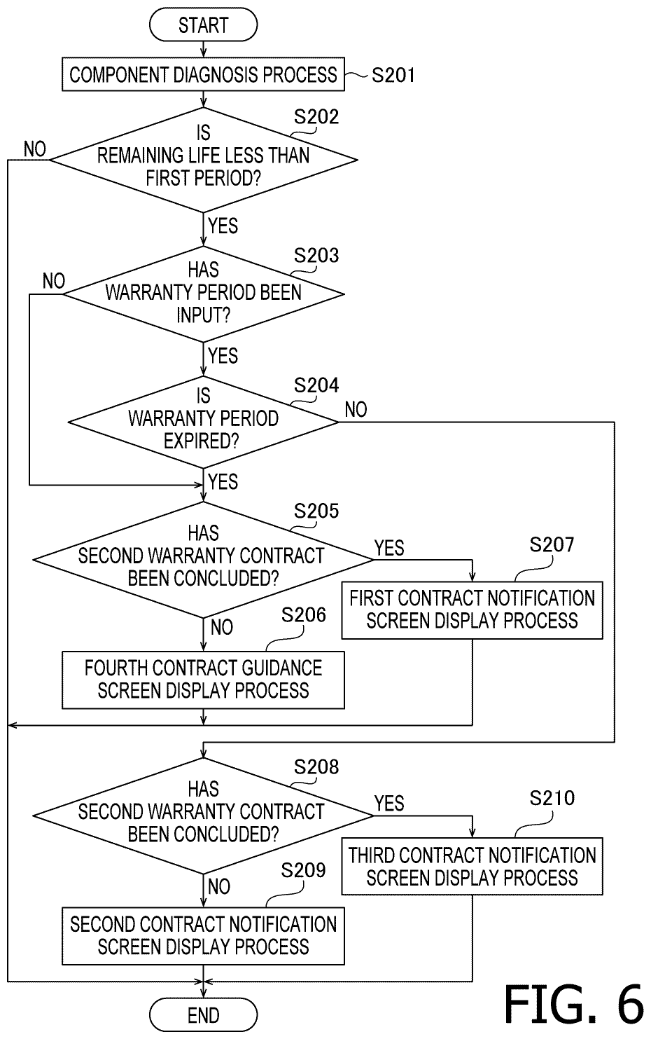

FIG. 6 is a flowchart showing a processing flow for performing a diagnosis of the remaining service life of a replaceable component.

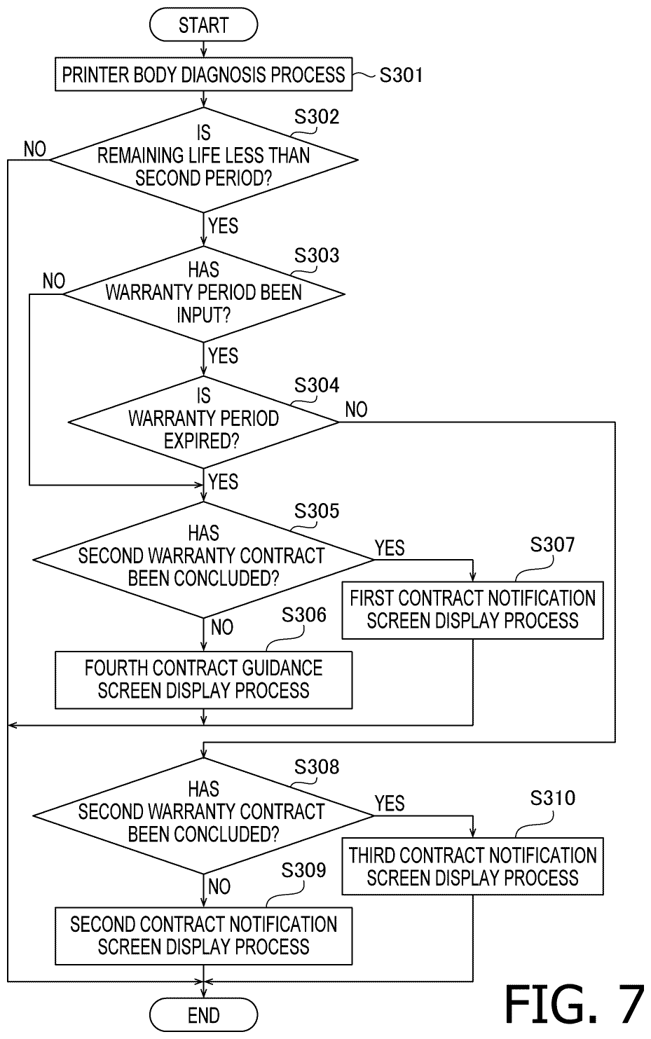

FIG. 7 is a flowchart showing a processing flow for performing a diagnosis of the remaining service life of the printer main body.

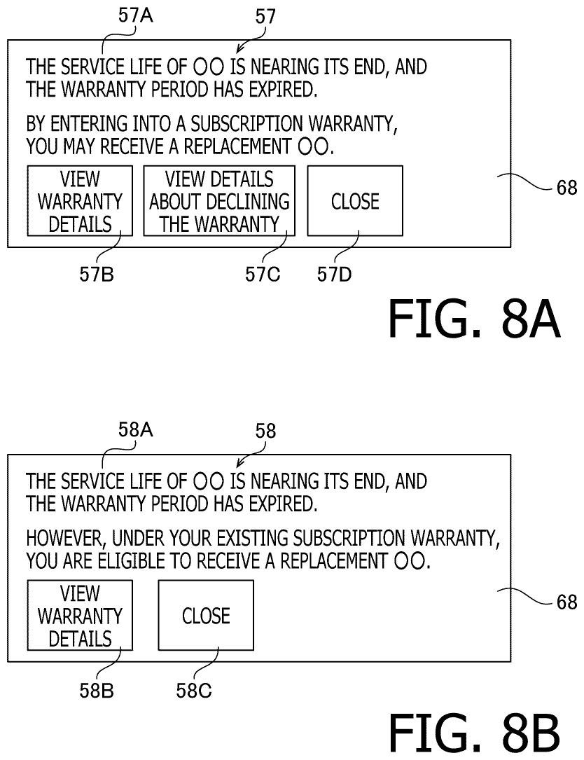

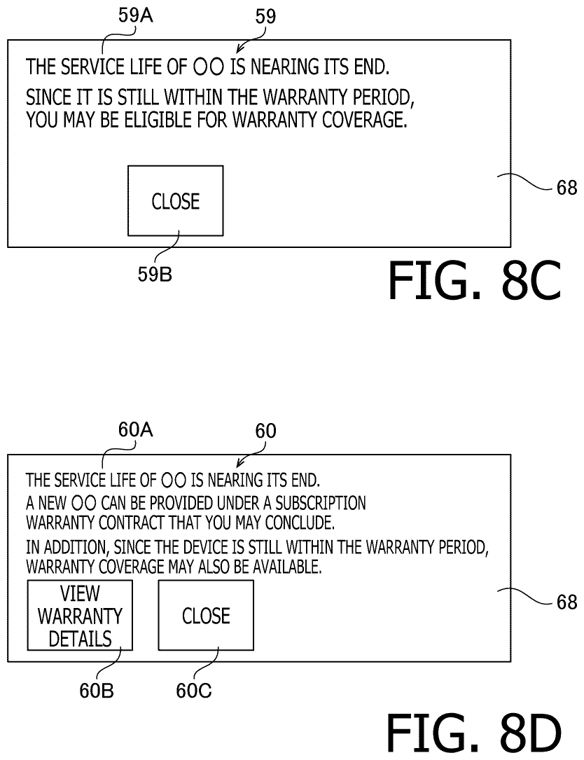

FIG. 8A illustrates a fourth contract guidance screen.

FIG. 8B illustrates a first warranty notification screen.

FIG. 8C illustrates a second warranty notification screen.

FIG. 8D illustrates a third warranty notification screen.

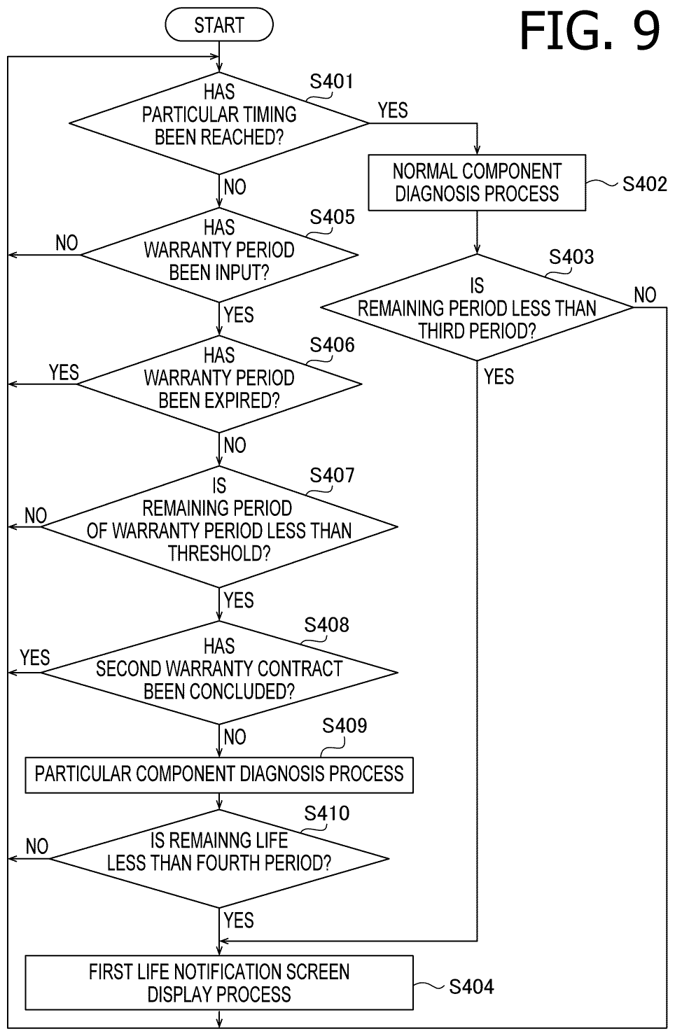

FIG. 9 is a flowchart showing a processing flow for performing a diagnosis of replaceable components.

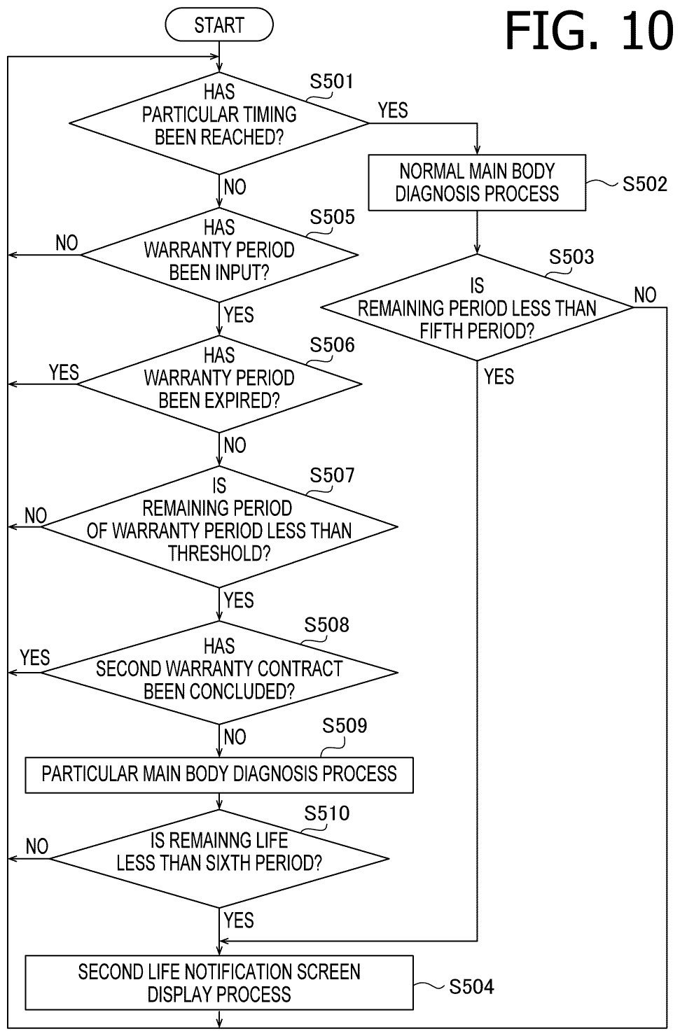

FIG. 10 is a flowchart showing a processing flow for performing a diagnosis of the printer main body.

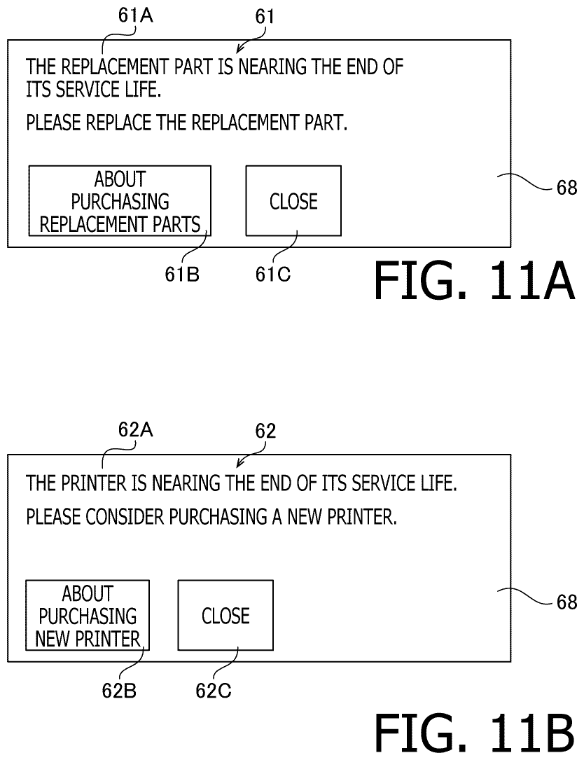

FIG. 11A illustrates a first service life notification screen.

FIG. 11B illustrates a second service life notification screen.

### DESCRIPTION

### First Embodiment

Hereinafter, a first embodiment according to aspects of the present disclosure is described.

### Overview of Printer

As shown in FIG. 1, a printer 1 includes a carriage 2, a sub tank 3, an inkjet head 4, a platen 5, conveyance rollers 6 and 7, and a maintenance unit 8. In is noted that the printer 1 corresponds to a “control device” according to aspects of the present disclosure.

It should be understood that, throughout this specification and the claims, the terms “unit” and “section” are intended to refer to hardware-based components, assemblies, or structural elements, unless expressly indicated otherwise. In this context, “unit” may refer to a discrete hardware component or device comprising one or more physical elements, and “section” may refer to a defined portion of such a structure or component.

The carriage 2 is supported by two guide rails 11 and 12 that extend in a scanning direction. The carriage 2 is connected to a carriage motor 86 shown in FIG. 2 via a belt (e.g., an endless belt; not shown). When the carriage motor 86 is driven, the belt is caused to move in a scanning direction, thereby moving the carriage 2 along the guide rails 11 and 12 in the scanning direction. Right and left sides along the scanning direction are defined as shown in FIG. 1, and are referred to as such in the following description.

A sub tank 3 is mounted on the carriage 2. Four cartridge mounting sections 23, aligned in the scanning direction, are provided at the right end of the printer 1 in the scanning direction and at the downstream end in a conveying direction, which is horizontal and orthogonal to the scanning direction. An ink cartridge 24 is removably mounted in each of the cartridge mounting sections 23. The four ink cartridges 24 store black, yellow, cyan, and magenta inks, in this order from the rightmost cartridge mounting section 23 in the scanning direction. These cartridges are connected to the sub tank 3 via four tubes 25, and the four colors of ink stored in the cartridges are supplied to the sub tank 3 through the tubes.

The inkjet head 4 is mounted on the carriage 2 and is attached to a lower surface of the sub tank 3. The inkjet head 4 is supplied with four color inks from the sub tank 3. The inkjet head 4 ejects ink through a plurality of nozzles 10 formed on its lower surface, which serves as a nozzle surface 4a. More specifically, the nozzles 10 are arranged in the conveying direction to form nozzle rows 9, and four nozzle arrays 9 are aligned in the scanning direction on the nozzle surface 4a. The nozzles eject black, yellow, cyan, and magenta inks, in this order from the nozzle array located on the right side in the scanning direction.

The platen 5 is positioned below the inkjet head 4 and faces the plurality of nozzles 10. The platen 5 extends over the entire length of a recording sheet S in the scanning direction and supports the recording sheet from below. A conveying roller 6 is located upstream of the inkjet head 4 and the platen 5 in the conveying direction, while another conveying roller 7 is located downstream. The conveying rollers 6 and 7 have their axes aligned in the scanning direction and are connected to a conveying motor 87 (FIG. 2) via gears or the like (not shown). When the conveying motor 87 is driven, the conveying rollers 6 and 7 rotate to feed the recording sheet S in the conveying direction.

The maintenance unit 8 includes a cap 31, a suction pump 32, and a waste liquid tank 33. The cap 31 is disposed on the right side of the platen 5 in the scanning direction. When the carriage 2 is moved to a maintenance position located on the right side of the platen 5 in the scanning direction, the plurality of nozzles 10 are brought into opposition with the cap 31.

The cap 31 is connected to a cap lifting mechanism 88 shown in FIG. 2. When the cap lifting mechanism 88 is actuated, the cap 31 is moved up and down. With the carriage 2 positioned at the maintenance position such that the plurality of nozzles 10 face the cap 31, raising the cap 31 causes its upper end to contact the nozzle surface 4a, thereby placing the nozzles 10 in a capped state. In a lowered state, the cap 31 does not cover the nozzles 10. The cap 31 need not necessarily cover the nozzles 10 by directly contacting the nozzle surface 4a. For example, the cap 31 may contact a frame (not shown) provided around the nozzle surface 4aof the inkjet head 4 to achieve coverage.

The suction pump 32, such as a tube pump, is connected to the cap 31 and the waste liquid tank 33. In the maintenance unit 8, when the suction pump 32 is driven while the cap 31 is in the capped state, a so-called suction purge is performed to discharge ink from the nozzles 10 in the inkjet head 4. The ink discharged through the suction purge is stored in the waste liquid tank 33.

For convenience, the above description assumes that the cap 31 covers all of the nozzles 10 collectively and that the suction purge discharges ink from all of the nozzles 10. However, the configuration is not limited to this. For example, the cap 31 may include a portion that covers the nozzles 10 of the rightmost nozzle row 9 for black ink and another portion that covers the nozzles 10 of the left three nozzle rows 9 for color inks, thereby allowing selective purging of either black or color ink from the inkjet head 4. Here, the color inks may refer to yellow, cyan, and magenta inks. Alternatively, separate caps 71 may be provided for each nozzle row 9, enabling nozzle-by-nozzle suction purging.

### Electrical Configuration of Printer

Next, an electrical configuration of the printer 1 is described. As shown in FIG. 2, the printer 1 includes a controller 80. The controller 80 includes a CPU (Central Processing Unit) 81, a ROM (Read Only Memory) 82, a RAM (Random Access Memory) 83, a memory 84, and an ASIC 85 (Application Specific Integrated Circuit). The controller 80 controls components such as the carriage motor 86, the inkjet head 4, the conveying motor 87, the cap lifting mechanism 88, and the suction pump 32.

In addition to the components described above, the printer 1 further includes a display unit 68 and an operation unit 69. The display unit 68 is, for example, a liquid crystal display. Under the control of the controller 80, various screens are shown on the display unit 68. The operation unit 69 may include hard keys or a touch panel integrated with the display unit 68. When the operation unit 69 is manipulated by the user, a signal corresponding to the operation is sent to the controller 80. In the present embodiment, the operation unit 69 corresponds to the “input unit” according to aspects of the present disclosure.

The controller 80 may perform various processes using only the CPU 81, only the ASIC 85, or a combination of both. Further, the controller 80 may include a single CPU 81, or multiple CPUs 81 that share processing tasks. Similarly, the controller 80 may include a single ASIC 85, or multiple ASICs 85 that perform distributed processing.

### Control During Recording

Next, the operation of the controller 80 for recording an image on the recording sheet S in the printer 1 will be described. Upon receiving a print instruction to record an image on the recording sheet S, the controller 80 controls the carriage motor 86 to move the carriage 2 in the scanning direction while simultaneously controlling the inkjet head 4 to eject ink from the nozzles 10 onto the sheet during a recording pass. The controller also controls the conveying motor 87 to drive the conveying rollers 6 and 7, thereby conveying the recording sheet S by a particular distance in the conveying direction. By repeating the recording pass and transport operation, the image is recorded on the recording sheet S.

The controller 80 receives a print instruction, for example, when the user performs a print operation via the operation unit 69 of the printer 1. Alternatively, if the printer 1 is connected to an external device such as a PC or smartphone (not shown), the print instruction may be received from the external device in response to a user operation performed thereon.

Process When Warranty Period Information of First Warranty Contract is Input

Next, the operation of the controller 80 when receiving input regarding a warranty period of a first warranty contract will be described. The first warranty contract refers to a warranty agreement concluded by, for example, the manufacturer of the printer 1, the dealer, an insurance provider, a repair technician, or a repair service provider. The warranty period of the first warranty contract is set by such entities. In this specification, for convenience, a warranty contract individually entered into by the user is referred to as the “first warranty contract.” The warranty period of the first warranty contract may be the same as, or different from, those of a second warranty contract described later.

If the first warranty contract is provided by the manufacturer or dealer of the printer 1, its warranty period may be defined based on the purchase date of the printer 1. If it is provided by an insurance company, the warranty period may be set based on the contract date. If the warranty is offered by a repair service provider or technician, the warranty period may be defined based on the repair date of the printer 1.

In the printer 1, the controller 80 performs processing in accordance with the flowchart shown in FIGS. 3A and 3B to carry out input operations related to the first warranty contract. For example, such processing is executed when the printer 1 is powered on.

Referring now to the flowchart of FIGS. 3A and 3B in more detail, the controller 80 first determines whether the warranty period for the first warranty contract has already been entered (Step S101). This determination is made based on whether warranty period information for the first warranty contract is stored in the memory 84. In the present embodiment, the memory 84 corresponds to the “storage unit” according to aspects of the present disclosure.

If input regarding the warranty period of the first warranty contract has already been made (S101: YES), the process proceeds to S110. If no such input has been made (S101: NO), the controller 80 executes an input selection screen display process (S102). In this process, the controller 80 causes the display unit 68 to present an input selection screen 51, such as that shown in FIG. 4A.

The input selection screen 51 includes a message area 51A and selection areas 51B, 51C, and 51D. The message area 51A displays a message describing the benefits of entering warranty period information and inquiring whether the user wishes to proceed with such input. The selection area 51B allows the user to choose to enter the warranty period information. The selection area 51C allows the user to opt not to enter the warranty period information. The selection area 51D allows the user to defer the input and choose to enter the warranty period information at a later time.

When the operation unit 69 includes a touch panel integrated with the display unit 68, the user may select the selection area 51B or 51C by touching the respective portions on the screen. When the operation unit 69 includes hardware keys, the user may make selections by operating the corresponding keys. The same applies to other selection areas described below.

Returning to FIG. 3A, after displaying the input selection screen in S102, the controller 80 waits until the user selects one of the available options: to enter the warranty period information now (by selecting area 51B), not to enter the information (area 51C), or to defer the entry (area 51D). The process continues to loop until one of these selections is made (S103: NO, S104: NO, S105: NO).

If the user selects the selection area 51D to defer input of the warranty period information (S105: YES), the controller 80 executes a waiting period count process (S106). In S106, the controller tracks a particular standby period, such as one month. After this standby period elapses, the process returns to S102 to again prompt the user.

If the user selects the selection area 51C to opt out of entering warranty period information for the first warranty contract (S104: YES), the controller 80 proceeds to determine whether a second warranty contract has already been concluded (S107). This determination may be made, for example, by referring to contract data stored in the memory 84, which includes information indicating whether the second warranty contract has been concluded. Alternatively, if the printer 1 is connected to an external server (not shown), the controller 80 may retrieve the contract information from the server to make this determination.

The second warranty contract is distinct from the first warranty contract described above. Specifically, the second warranty contract is a subscription-based contract in which warranty coverage continues in exchange for a periodic fee. This fee may remain constant or vary from period to period. The coverage may include repairs or partial replacements due to wear or deterioration, or complete replacement of the printer 1. Partial replacement may involve components such as transport rollers 6 and 7 or the waste liquid tank 33. The coverage may also optionally include consumables such as ink cartridges 24. For convenience, this type of warranty contract is referred to herein as a “second warranty contract.”

If it is determined that the second warranty contract has already been concluded (S107: YES), the process is terminated. Accordingly, when no input regarding the first warranty contract has been made but the second warranty contract is in effect, the first contract guidance screen 52, which will be described later, is not displayed on the display unit 68.

If the second warranty contract has not been concluded (S107: NO), the controller 80 executes a process to display the first contract guidance screen (S108), and then the process is terminated. In S108, the controller 80 causes the display unit 68 to display the first contract guidance screen 52, such as the one shown in FIG. 4B.

As shown in FIG. 4B, the first contract guidance screen 52 includes a message area 52A and selection areas 52B and 52C. The message area 52A notifies the user that warranty period information for the first warranty contract has not been entered and displays a message prompting the user to enter into the second warranty contract.

The selection area 52B is used to display details about the second warranty contract. When this area is selected, the controller 80 causes the display unit 68 to display a detail screen 53, for example, as shown in FIG. 4C.

The detail screen 53 includes a message area 53A, a URL display area 53B, a code display area 53C, and a selection area 53D. The message area 53A displays a message prompting the user to access a website that provides details of the second warranty contract. The URL display area 53B shows the address of the website. The code display area 53C displays a two-dimensional code (e.g., QR code) that can be scanned by a smartphone or the like to access the same website. Although not described in detail, the user may enter into the second warranty contract by performing a particular operation on the website and communicating with a server (not shown). The selection area 53D is used to close the detail screen 53. When the selection area 53D is selected, the display returns to the first contract guidance screen 52.

The selection area 52C is used when the user decides that the second warranty contract is not necessary. When this area is selected, the display of the first contract guidance screen 52 is terminated.

Returning to FIG. 3A, if the selection area 51B is selected in the input selection screen 51 (FIG. 4A), indicating that the user wishes to input warranty period information for the first warranty contract (S103: YES), the controller 80 performs an input screen display process (S109). In this process, the controller 80 causes the display unit 68 to display an input screen 54, such as that shown in FIG. 5A.

The input screen 54 includes a message area 54A, a numeric selection area 54B, an input result display area 54C, and a confirmation area 54D. The message area 54A prompts the user to input the warranty expiration date of the first warranty contract. The numeric selection area 54B allows the user to enter digits “0” through “9” to specify the date. The input result display area 54C shows the entered expiration date. The confirmation area 54D is selected when the input is complete.

Although the input screen 54 in FIG. 5A is designed for entering the expiration date of the first warranty contract, it may alternatively be used to enter other warranty-related information, such as the warranty period itself or the printer's purchase date. In addition, the operation unit 69 may include numeric hard keys (“0” to “9”), in which case the input screen 54 may omit the numeric selection area 54B. The user can then enter the warranty date directly via the hard keys.

Returning again to FIG. 3B, after the input screen has been displayed (S109), the controller 80 waits until the user completes the input, i.e., until selection area 54D is selected (S110: NO). Once input of the warranty period is completed (S110: YES), the controller 80 stores the warranty period information—based on the input from the operation unit 69—into memory 84 (S111), and the process then proceeds to S112.

In S112, the controller 80 determines whether a second warranty contract has already been concluded, in the same manner as in S107. If the second warranty contract has already been concluded (S112: YES), the process terminates. As a result, when the first warranty period has been entered and the second warranty contract is in effect, the second contract guidance screen 55 and third contract guidance screen 56—described later—are not displayed on the display unit 68.

If the second warranty contract has not been concluded (S112: NO), the controller 80 checks whether the first warranty period has already expired, based on the stored warranty information (S113). If the warranty period has expired (S113: YES), the controller 80 executes the second contract guidance screen display process (S114), and then the process terminates. In this step, the controller causes the display unit 68 to display the second contract guidance screen 55, for example, as shown in FIG. 5B.

The second contract guidance screen 55, shown in FIG. 5B, includes a message area 55A and selection areas 55B and 55C. The message area 55A displays a notification that the warranty period of the first warranty contract has expired, along with a prompt to enter into a second warranty contract. The selection areas 55B and 55C function similarly to those in the first contract guidance screen 52 (i.e., areas 52B and 52C).

Returning to FIG. 3B, if the first warranty period has not expired (S113: NO), the controller 80 determines whether the remaining period is less than a particular threshold (S115). If the remaining period is equal to or greater than the threshold, the process is terminated. If it is below the threshold (S115: YES), the controller 80 executes the third contract guidance screen display process (S116), and then the process is terminated. In this step, the third contract guidance screen 56 is displayed, for example as shown in FIG. 5C.

The third contract guidance screen 56, shown in FIG. 5C, includes a message area 56A and selection areas 56B and 56C. The message area 56A displays a message informing the user that the expiration of the first warranty contract is approaching and prompting the user to enter into a second warranty contract. The selection areas 56B and 56C function in the same manner as the corresponding selection areas 52B and 52C in the first contract guidance screen 52. In this embodiment, when the second warranty contract is concluded while the first warranty contract is still valid, the second warranty contract is normally set to commence immediately. However, it may alternatively be configured to commence only upon the expiration of the first warranty contract. In such a case, the system may allow the user to choose between immediate commencement and deferred commencement of the second warranty contract, depending on the remaining duration of the first warranty contract.

### Diagnosis of Remaining Lifespan

Next, the processing performed by the controller 80 when diagnosing the remaining service life of replaceable components and the main body of the printer 1 will be described. The controller 80 performs a diagnostic process for each replaceable component in accordance with the flowchart shown in FIG. 6. Examples of the replaceable components include an ink cartridge 24, transport rollers 6 and 7, and a waste liquid tank 33. The controller 80 also performs a diagnostic process for the main body of the printer 1 in accordance with the flowchart shown in FIG. 7.

In the first embodiment, the processes illustrated in the flowcharts of FIGS. 6 and 7 may be executed when a user provides a diagnostic instruction via the operation unit 69, or when a particular timing condition is satisfied. The particular timing may correspond to, for example, a preset time of day, the elapse of a particular time interval, or the completion of printing on a particular number of recording sheets S. Alternatively, the processes may be triggered based on the occurrence of an error or failure signal within the printer 1.

Referring to the flowchart in FIG. 6 in greater detail, the controller 80 first executes a component diagnosis process (S201). In the process of S201, the controller 80 performs a diagnosis to assess the remaining service life of the replacement parts.

The component diagnosis may include, for example, assessing the remaining ink volume in the ink cartridge 24, the degree of wear of the conveying rollers 6 and 7, and the amount of waste ink accumulated in the waste liquid tank 33. These diagnostics may be performed based on signals from sensors installed in the printer 1 (not shown), the number of pages recorded since the replaceable component was installed, or the elapsed time.

Next, the controller 80 determines in step S202 whether the remaining service life of the replaceable component, as indicated by the results of the component diagnosis in S201, is less than a first period. The first period may be defined in terms of time, such as “X days remaining,” or as a percentage of the total service life, such as “Y % remaining.” The same applies to the second through sixth periods described later. The first period may be the same for all replaceable components or may vary depending on the component.

If the remaining service life of the replaceable component is equal to or greater than the first threshold period (S202: NO), the process is terminated. If the remaining service life is less than the first threshold period (S202: YES), the controller 80 proceeds to determine, in the same manner as in S101, whether information relating to the warranty period of the first warranty contract has been entered (S203). If such information has not been entered (S203: NO), the process proceeds to step S205. If the warranty period information has been entered (S203: YES), the controller then determines, in the same manner as in S111, whether the warranty period of the first warranty contract has already expired (S204). If the warranty period has expired (S204: YES), the process advances to step S205. If the warranty period has not expired (S204: NO), the process advances to step S208.

In S205, the controller 80 determines, in the same manner as in S105, whether a second warranty contract has already been concluded. If the second warranty contract has not been concluded (S205: NO), the controller 80 executes a display process for the fourth contract guidance screen (S206), after which the process ends. In the display process of S206, the controller 80 causes the display unit 68 to present the fourth contract guidance screen 57, such as the one shown in FIG. 8A.

As shown in FIG. 8A, the fourth contract guidance screen 57 includes a message area 57A and selection areas 57B, 57C, and 57D. The message area 57A displays a message informing the user that the service life of a particular replaceable component is nearing its end, that the first warranty period has expired, and that the user can receive a replaceable component if a second warranty contract is concluded. In other words, the message indicates that the replaceable component can be provided without requiring a separate purchase. The “XX” portion of the message displayed in the message area 57A represents the name of the replaceable component diagnosed in step S201. This convention is similarly applied in FIGS. 8B through 8D.

The selection area 57B is used to view the details of the second warranty contract, and upon selection, the detail screen 53 shown in FIG. 4C is displayed on the display unit 68. The selection area 57C is used to proceed without entering into the second warranty contract. When selected, a separate purchase guidance screen (not shown) is displayed on the display unit 68 to guide the user through the replacement part purchase procedure. The selection area 57D is used to terminate the display of the fourth contract guidance screen 57. When selected, the screen is removed from the display unit 68.

Returning to FIG. 6, if it is determined that the second warranty contract has already been concluded (S205: YES), the controller 80 executes a first warranty notification screen display process (S207), and thereafter the processing is terminated. In this process, the controller 80 causes the display unit 68 to display the first warranty notification screen 58, such as the one shown in FIG. 8B.

The first warranty notification screen 58, shown in FIG. 8B, includes a message section 58A and selection areas 58B and 58C. The message section 58A displays a message notifying the user that the service life of a replaceable component is nearing its end and that, although the warranty period of the first warranty contract has expired, replaceable components can be provided under the already concluded second warranty contract. The selection areas 58B and 58C correspond to the selection areas 57B and 57D of the fourth contract guidance screen 57, respectively. Since the second warranty contract has already been concluded when this screen is displayed, selecting the selection area 58B causes the screen shown in FIG. 4C to be displayed, enabling the user to carry out procedures for receiving replaceable components under the second warranty contract. The same applies when the selection area 60B is selected on the third warranty notification screen 60 shown in FIG. 8D.

Returning to FIG. 6, in step S208, the controller 80 determines, in the same manner as in step S105, whether the second warranty contract has been concluded. If it has not been concluded (S208: NO), the controller 80 executes a second warranty notification screen display process (S209), after which the processing is terminated. In this process, the controller 80 causes the display unit 68 to display the second warranty notification screen 59, such as the one shown in FIG. 8C.

The second warranty notification screen 59 shown in FIG. 8C includes a message section 59A and a selection area 59B. The message section 59A displays a message informing the user that either a replaceable component or the main body of the printer 1 is nearing the end of its service life and that, because the first warranty period is still valid, coverage under the first warranty contract may be available. The selection area 59B functions in the same manner as selection area 57D of the fourth contract guidance screen 57.

If the second warranty contract has been concluded (S208: YES), the controller 80 executes a third warranty notification screen display process (S210), after which the processing is terminated. In this step, the controller causes the display unit 68 to display the third warranty notification screen 60, such as the one shown in FIG. 8D.

The third warranty notification screen 60, as shown in FIG. 8D, includes a message section 60A and selection areas 60B and 60C. The message section 60A displays a message informing the user that the replaceable component is nearing the end of its service life, that the replaceable component may be provided under the already concluded second warranty contract, and that coverage under the first warranty contract may also be available since the device is still within the first warranty period. However, the message displayed in the message section 60A may alternatively omit the notification about the availability of coverage under the first warranty contract and instead inform only that the replaceable component is available under the second warranty contract. The selection areas 60B and 60C correspond to the selection areas 57B and 57D of the fourth contract guidance screen 57, respectively.

The flowchart in FIG. 7 will now be described in detail. When executing the process in accordance with this flowchart, the controller 80 first executes a main body diagnosis process (S301). In step S301, the controller performs a diagnosis to determine the remaining service life of the main body of the printer 1.

The main body diagnosis refers to a diagnosis of the degree of deterioration of specific components of the printer 1 other than the replaceable components. This diagnosis may be performed based on, for example, signals from sensors provided in the printer 1 (not shown), the number of pages recorded since the initial use of the printer, or the elapsed time.

Next, in step S302, the controller 80 determines whether the remaining service life of the main body of the printer 1, as indicated by the result of the main body diagnosis in S301, is less than a second threshold period. The second threshold period may be the same as the first threshold period defined for any of the replaceable components, or may differ from the first threshold period for all replaceable components.

If the remaining service life of the main body of the printer 1 is greater than or equal to the second threshold period (S302: NO), the process is terminated. If the remaining service life is less than the second threshold period (S302: YES), the controller 80 proceeds to execute steps S303 to S310, in a manner similar to steps S203 to S210 for the replaceable components.

In steps S306, S307, S309, and S310, the placeholder “XX” in the screens shown in FIGS. 8A through 8D is replaced with “printer body.” When the selection area 57C is selected on the fourth contract guidance screen 57 (S306), a purchase guidance screen (not shown) is displayed on the display unit 68 to guide the user through the process of purchasing a new printer. Additionally, when the selection area 58B or 60B is selected on the first or third warranty notification screens displayed in S307 or S309, respectively, a homepage (as shown in FIG. 4C) is displayed, from which the user can proceed with procedures for obtaining a replacement printer under the second warranty contract.

### Effect

In the first embodiment, the input screen 54 for entering the warranty period of the first warranty contract is displayed on the display unit 68, and based on the input regarding the warranty period made through the operation panel 69, the controller stores warranty period information in the memory 84. This enables the printer 1 to operate in a manner appropriate to whether it is within the warranty period of the first warranty contract. In other words, the printer can perform operations that are optimal for the user depending on whether the warranty is still valid or has expired. For example, although the user may remember the warranty period at the time of purchasing the printer 1, they may later forget it as time passes. In such cases, even if the printer is still within the warranty period, the user may not be able to receive proper warranty support. According to the first embodiment, by storing the warranty period information in the memory 84 while the user still remembers the warranty period (e.g., shortly after purchase), the user can be appropriately notified based on the stored information even if they later forget the warranty period, thereby increasing the likelihood of receiving appropriate warranty service.

Furthermore, in the first embodiment, when no input has been made regarding the warranty period of the first warranty contract and a second warranty contract has not been concluded, the controller causes the first contract guidance screen 52 to be displayed on the display unit 68. This enables the user to be prompted to conclude a second warranty contract in cases where it is unclear whether the warranty under the first warranty contract is applicable and no second warranty contract has been established.

On the other hand, even if no input has been made regarding the warranty period of the first warranty contract and it is therefore unclear whether the warranty period has expired, the first contract guidance screen 52 is not displayed if a second warranty contract has already been concluded, thereby avoiding unnecessary display.

Additionally, in the first embodiment, when the warranty period of the first warranty contract has been entered but has already expired, and a second warranty contract has not been concluded, the controller causes the second contract guidance screen 55 to be displayed. This enables the user to be prompted to conclude the second warranty contract in cases where the warranty under the first warranty contract is no longer available and no second warranty contract has been established. On the other hand, even if the warranty under the first warranty contract is no longer available, the second contract guidance screen 55 is not displayed if a second warranty contract has already been concluded, thereby avoiding unnecessary display.

Furthermore, in the first embodiment, when the input for the warranty period of the first warranty contract has been made and the warranty period has not yet expired, but the remaining duration of the first warranty period is less than a particular remaining period, the controller causes the third contract guidance screen 56 to be displayed on the display unit 68 if the second warranty contract has not been concluded. If the second warranty contract has already been concluded, the third contract guidance screen 56 is not displayed. This configuration enables the user to be encouraged to conclude the second warranty contract when the remaining duration of the first warranty period is short and no second warranty contract is in place. On the other hand, even if the remaining duration is short, the display of the third contract guidance screen 56 is suppressed when the second warranty contract has already been concluded, thereby preventing unnecessary prompts.

Furthermore, in the first embodiment, when the input for the warranty period of the first warranty contract has been made, the warranty period has not expired, and the remaining duration of the first warranty period is equal to or greater than a particular remaining period, the third contract guidance screen 56 is not displayed on the display unit 68, regardless of whether the second warranty contract has been concluded. This configuration prevents unnecessary display of guidance when a sufficient amount of warranty coverage remains.

Furthermore, in the first embodiment, when the result of the diagnosis regarding the service life of a replaceable component or the printer body indicates that the remaining service life of the replaceable component is less than a first threshold period or that of the printer body is less than a second threshold period—in other words, when the component or printer body is nearing the end of its service life—and if it is either unclear whether the first warranty contract remains valid or the first warranty contract has already expired, and the second warranty contract has not been concluded, the fourth contract guidance screen 57 is displayed on the display unit 68. This enables the system to prompt the user to consider concluding the second warranty contract at the point in time when the replaceable component or the printer body is found to have a short remaining service life and the first warranty coverage is either uncertain or unavailable.

Furthermore, in the first embodiment, when the result of a diagnosis indicates that the remaining service life of a replaceable component is less than a first threshold period or that of the printer body is less than a second threshold period—in other words, when the component or the printer body is nearing the end of its service life—and it is either unclear whether the first warranty contract is still valid or it has already expired, and a second warranty contract has been concluded, the controller causes the first warranty notification screen 58 to be displayed on the display unit 68. This enables the user to be informed that coverage is available under the concluded second warranty contract, thereby making it easier for the user to receive appropriate warranty support.

Additionally, in the first embodiment, when the result of a diagnosis indicates that the remaining service life of a replaceable component is less than a first threshold period or that of the printer body is less than a second threshold period—in other words, that the replaceable component or the printer body is nearing the end of its service life—and the first warranty period has not yet expired, but a second warranty contract has not been concluded, the controller causes the second warranty notification screen 59 to be displayed on the display unit 68. This informs the user that warranty coverage under the first warranty contract may still be available, thereby making it easier for the user to obtain appropriate support.

Furthermore, in the first embodiment, when the result of a diagnosis indicates that the remaining service life of a replaceable component is less than a first threshold period, or that of the printer body is less than a second threshold period—that is, when either is nearing the end of its service life—and the first warranty period has not yet expired and a second warranty contract has already been concluded, the controller causes the third warranty notification screen 60 to be displayed on the display unit 68. This informs the user that coverage is available under the second warranty contract, thereby facilitating the receipt of such support. In addition, in this case, the system may also notify the user that coverage may still be available under the first warranty contract, further improving access to appropriate support.

Furthermore, in the first embodiment, the second warranty contract is configured as a subscription agreement in which warranty coverage continues upon payment of a predetermined fee at particular intervals. Accordingly, even after the warranty period of the first warranty contract has expired, continued warranty support is available under the second warranty contract. The coverage of the second warranty contract may include the provision of replacement parts, repair services, or the entire product itself when replacement or repair of either the product or its components is required. The term “provision” encompasses both complimentary and fee-based services and does not necessarily imply free replacement or repair.

### Second Embodiment

A second embodiment according to aspects of the present disclosure will now be described. This embodiment also pertains to the printer 1, similarly to the first embodiment. However, unlike the first embodiment, in the second embodiment, the controller 80 performs processing for diagnosing the service life of each of the replaceable components of the printer 1 based on the flowchart shown in FIG. 9. Furthermore, the controller 80 performs processing for diagnosing the service life of the main body of the printer 1 based on the flowchart shown in FIG. 10. In the second embodiment, for example, the processing according to FIGS. 9 and 10 is initiated when the printer 1 is powered on and continues while the printer remains in the powered-on state.

Details of the flowchart in FIG. 9 will now be described. In the flowchart of FIG. 9, the controller 80 first determines whether a particular timing condition is satisfied (S401). The particular timing condition in S401 may be similar to that described in the first embodiment.

If the particular timing condition is satisfied (S401: YES), the controller 80 executes a normal component diagnosis process (S402). In this process, the controller performs a normal component diagnosis to evaluate the remaining service life of the replaceable components. The normal component diagnosis may be implemented in a manner similar to the component diagnosis described in the first embodiment.

Next, the controller 80 determines whether the remaining service life of the replaceable component, as indicated by the result of the normal component diagnosis in S402, is less than a particular period referred to as the third period (S403). The third period may be common to all replaceable components or may differ depending on the component. It may also be the same as or different from the first period described in the first embodiment.

If the remaining service life of the replaceable component is greater than or equal to the third period (S403: NO), the process returns to S401. If the remaining service life is less than the third period (S403: YES), the controller 80 executes a first service life notification screen display process (S404), after which the process returns to S401. In the process of S404, the controller 80 causes the display unit 68 to present the first service life notification screen 61, such as the one shown in FIG. 11A.

The first service life notification screen 61, shown in FIG. 11A, includes a message section 61A and selection areas 61B and 61C. The message section 61A displays a message notifying the user that the service life of a replaceable component is nearing its end and prompting the user to perform a replacement. The selection area 61B is used to initiate the purchase of a replaceable component. When selection area 61B is selected, a purchase guidance screen is displayed on the display unit 68, similar to the one that appears when selection area 57C is chosen in the fourth contract guidance screen 57 from the first embodiment. The user can proceed with the purchase process based on this guidance screen. The selection area 61C functions in the same manner as selection area 57D in the fourth contract guidance screen 57.

Returning to FIG. 9, if the particular timing condition is not satisfied (S401: NO), the controller 80 determines whether input regarding the warranty period of the first warranty contract has been made (S405), in the same manner as in S101 of the first embodiment. If the input has not been made (S405: NO), the process returns to S401.

If input regarding the warranty period has been made (S405: YES), the controller 80 determines whether the warranty period of the first warranty contract has expired (S406), in the same manner as in S111 of the first embodiment. If the warranty period has expired (S406: YES), the process returns to S401.

If the warranty period of the first warranty contract has not expired (S406: NO), the controller 80 determines whether the remaining period of the first warranty contract is less than a particular remaining period (S407), in the same manner as in S113 of the first embodiment. If the remaining period is equal to or greater than the particular remaining period (S407: NO), the process returns to S401.

If the remaining period of the first warranty contract is less than the particular remaining period (S407: YES), the controller 80 determines whether a second warranty contract has already been concluded (S408), in the same manner as in S105 of the first embodiment. If the second warranty contract has been concluded (S408: YES), the process returns to S401.

If the second warranty contract has not been concluded (S408: NO), the controller 80 executes a special replaceable component diagnosis process (S409). In this process, the controller performs a special diagnosis to evaluate the remaining service life of the replaceable component.

The special replaceable component diagnosis may be the same as the normal replaceable component diagnosis in terms of evaluation method. In such cases, it is considered a separate diagnosis from the normal one due to differences in the conditions under which it is initiated. Alternatively, the special replaceable component diagnosis may involve, for example, a more time-consuming evaluation than the normal diagnosis. Or, for instance, while the normal diagnosis is performed by the printer 1 alone, the special diagnosis may be performed through communication between the printer 1 and an external server (not shown).

The controller 80 then determines, in step S410, whether the remaining service life of the replaceable component indicated by the result of the special replaceable component diagnosis is less than a fourth threshold period, which is longer than the third threshold period defined in S403. The fourth threshold period may be the same for all replaceable components or may differ depending on the specific component.

If the remaining service life of the replaceable component is equal to or greater than the fourth threshold period (S410: NO), the process returns to S401. If the remaining service life is less than the fourth threshold period (S410: YES), the controller 80 executes the first service life notification screen display process (S404), and then the process returns to S401.

The flowchart in FIG. 10 will now be described in detail. In this flowchart, the controller 80 first determines whether a particular timing condition is satisfied (S501). The timing condition in S501 may be the same as that described in the first embodiment.

If the particular timing condition is satisfied (S501: YES), the controller 80 executes a normal body diagnosis process (S502). In this process, the controller evaluates the remaining service life of the printer body. This normal body diagnosis may be similar to the body diagnosis described in the first embodiment.

Next, the controller 80 determines whether the remaining service life of the printer body, as indicated by the result of the normal body diagnosis in S502, is less than a particular fifth period (S503). This fifth period may be the same as or different from the third period. If the remaining service life is equal to or greater than the fifth period (S503: NO), the process returns to S501.

If the remaining service life of the printer body is less than the particular fifth period (S503: YES), the controller 80 executes a second service life notification screen display process (S504), and then the process returns to S501.

In the process of S504, the controller 80 causes the display unit 68 to display a second service life notification screen 62, such as the one shown in FIG. 11B.

The second service life notification screen 62 includes a message area 62A and selection areas 62B and 62C. The message area 62A displays a message notifying the user that the printer body is nearing the end of its service life and prompting the user to consider purchasing a new printer. When the selection area 62B is selected, a purchase guidance screen is displayed on the display unit 68, similar to the one presented when selection area 57C is chosen in the fourth contract guidance screen 57 described in the first embodiment. Based on this guidance screen, the user can proceed with the procedures for purchasing the printer. The selection area 62C functions in the same manner as selection area 57D in the fourth contract guidance screen 57.

Returning to FIG. 10, if the particular timing condition is not satisfied (S501: NO), the controller 80 executes processes S505 through S508, which follow the same logic as steps S405 through S408 in the second embodiment.

If input for the warranty period of the first warranty contract is present (S505: YES), the warranty has not yet expired (S506: NO), the remaining period is less than a particular threshold (S507: YES), and the second warranty contract has not been concluded (S508: NO), the controller 80 executes a special body diagnosis process (S509). In this process, the controller performs a special diagnostic evaluation of the remaining service life of the main body of the printer 1.

The special body diagnosis may be functionally the same as the normal body diagnosis but differs in that it is initiated under different conditions. Alternatively, the special body diagnosis may involve a more time-consuming evaluation than the normal diagnosis. In some cases, while the normal body diagnosis is performed solely by the printer 1, the special body diagnosis may be carried out through communication between the printer 1 and an external server (not shown).

The controller 80 then determines whether the remaining service life of the printer body, as indicated by the result of the special body diagnosis in S509, is less than a sixth period that is longer than the fifth period used in S503 (S510). The sixth period may be the same as the fourth period used for any of the replaceable components or may differ from all of them. If the remaining service life of the printer body is greater than or equal to the sixth period (S510: NO), the process returns to S501. If it is less than the sixth period (S510: YES), the controller executes the second service life notification screen display process (S504), after which the process returns to S501.

### Effect

In the second embodiment, at a particular timing, a normal diagnosis is performed on the remaining service life of a replaceable component in the printer 1. If the result indicates that the remaining service life is shorter than a third threshold period, the controller displays the first service life notification screen 61 on the display unit, thereby informing the user that the service life of the replaceable component is nearing its end.

Conversely, if the first warranty contract is still valid but the remaining period is shorter than a particular threshold and no second warranty contract has been concluded, the controller performs a special diagnosis on the remaining service life of a replaceable component. If the result of the diagnosis indicates that the remaining service life is shorter than a fourth threshold period but longer than the third threshold period, the first service life notification screen 61 is displayed on the display unit 68. This enables earlier notification of the approaching end of service life of the replaceable component when the remaining period of the first warranty is short and no second warranty contract has been concluded.

In addition, in the second embodiment, when a normal diagnosis of the remaining service life of the printer body is performed at a particular timing and the result indicates that the remaining service life is shorter than a fifth threshold period, the second service life notification screen 62 is displayed on the display unit 68 to inform the user that the printer body is nearing the end of its service life.

On the other hand, when the first warranty contract is still valid but the remaining period is shorter than a particular remaining period and no second warranty contract has been concluded, and a special body diagnosis is performed, if the result of the diagnosis indicates that the remaining service life of the printer body is shorter than a sixth period that is longer than the fifth period, the controller displays the second service life notification screen 62 on the display unit 68. This allows the user to be promptly notified that the service life of the printer body is nearing its end, in situations where the remaining period of the first warranty contract is short and no second warranty contract has been concluded.

### MODIFICATIONS

Although preferred first and second embodiments of the present disclosure have been described above with reference to specific examples, aspects of the present disclosure are not limited to these embodiments. Various modifications, alternatives, and improvements-whether currently known or later developed-may be made to the first and second embodiments without departing from the spirit and scope of the present disclosure as defined in the claims. In the following modifications, components identical to those in the first and/or second embodiments will not be redundantly described.

In the first embodiment, the contract guidance screens 52, 55, 56, and 57 are described as separate screens; however, this configuration is not limiting. At least two of the screens among 52, 55, and 56 may be implemented as a single common screen.

Also in the first embodiment, when the warranty period of the first warranty contract has been entered via input screen 54, the period has not yet expired, and the remaining duration is equal to or longer than a predefined threshold, the system may be configured to display the third contract guidance screen 56 on the display unit 68 only if a second warranty contract has not been concluded. If the second warranty contract has already been concluded, the guidance screen is not displayed. In this case, the message shown in the message area 56A of the third contract guidance screen does not include any statement indicating that the first warranty period is nearing expiration.

Alternatively, in the first embodiment, when the warranty period of the first warranty contract has been entered via the input screen 54, the warranty period indicated by the warranty information has not yet expired, and the remaining period is equal to or greater than a particular threshold, the system may be configured to display the third contract guidance screen 56 on the display unit 68 regardless of whether a second warranty contract has been concluded. In such a case, however, the message displayed in the message area 56A of the third contract guidance screen 56 does not include any indication that the first warranty period is nearing expiration.

Further, in the first embodiment, even when the warranty period of the first warranty contract has been entered via the input screen 54, has not yet expired, and the remaining period is less than a particular threshold, the third contract guidance screen 56 may be omitted from being displayed on the display unit 68, regardless of whether a second warranty contract has been concluded.

Alternatively, in the first embodiment, when the warranty period of the first warranty contract has been entered via the input screen 54, and the period has not yet expired but the remaining time is less than a particular threshold, the third contract guidance screen 56 may be displayed on the display unit 68 regardless of whether a second warranty contract has been concluded.

Furthermore, in the first embodiment, when the warranty period of the first warranty contract has already expired based on the information entered via the input screen 54, the second contract guidance screen 55 may be displayed on the display unit 68 regardless of whether a second warranty contract has been concluded.

Alternatively, in the first embodiment, when the warranty period of the first warranty contract has expired as indicated by the warranty period information entered via the input screen 54, the second contract guidance screen 55 may be omitted from the display unit 68 regardless of whether a second warranty contract has been concluded.

In addition, in the first embodiment, when no input regarding the warranty period of the first warranty contract is provided via the input screen 54, the first contract guidance screen 52 may be displayed on the display unit 68 regardless of whether a second warranty contract has been concluded.

Alternatively, in the first embodiment, when no input regarding the warranty period of the first warranty contract is provided via the input screen 54, the first contract guidance screen 52 may be omitted from the display unit 68 regardless of whether a second warranty contract has been concluded.

Furthermore, in the first embodiment, when the result of the component diagnosis indicates that the remaining service life of a replaceable component is less than the first period, or the result of the body diagnosis indicates that the remaining service life of the printer body is less than the second period, and the warranty period of the first warranty contract has expired based on the input from input screen 54, and no second warranty contract has been concluded, the fourth contract guidance screen 57 may be omitted from the display unit 68.

In the first embodiment, when the result of the component diagnosis indicates that the remaining service life of a replaceable component is less than the first period, or the result of the body diagnosis indicates that the remaining service life of the printer body is less than the second period, and the warranty period of the first warranty contract has expired based on input from input screen 54, and a second warranty contract has been concluded, the first warranty notification screen 58 may be omitted from the display unit 68.

In the first embodiment, if the result of the component diagnosis indicates that the remaining service life of a replaceable component is less than the first period, or the result of the body diagnosis indicates that the remaining service life of the printer body is less than the second period, and the warranty period of the first warranty contract has been entered via input screen 54, and the first warranty period has not yet expired, and no second warranty contract has been concluded, the second warranty notification screen 59 may be omitted from the display unit 68.

Also, in the first embodiment, if the result of the component diagnosis indicates that the remaining service life of a replaceable component is less than the first period, or the result of the body diagnosis indicates that the remaining service life of the printer body is less than the second period, and input regarding the warranty period of the first warranty contract has been made via the input screen 54, and the first warranty period has not yet expired, and a second warranty contract has been concluded, then the second warranty notification screen 59 may be omitted from the display unit 68.

In the first and second embodiments, diagnostics were performed for both the replaceable components and the printer body. However, this is not a limitation. In each of these embodiments, it is also possible to perform only one of the two types of diagnostics—either for the replaceable components or for the printer body.

In the above examples, the second warranty contract is described as a subscription agreement under which coverage is continued by paying a specified fee at regular intervals. However, this is not limiting. For example, the second warranty contract may alternatively take the form of a one-time payment that allows warranty coverage to continue for a certain period after the expiration of the first warranty contract.

In the above examples, each screen was displayed over the entirety of the display unit 68. However, this is not limiting. A specific display area within the display unit 68 may be designated for presenting each screen, and the screens may be displayed within that area. Alternatively, each screen may be presented as a pop-up in a portion of the display unit 68.

While the foregoing description cites examples in which the replaceable components of the printer include the ink cartridge 24, the conveying rollers 6 and 7, and the waste liquid tank 33, the replaceable components are not limited to these. The printer's replaceable components may include only a subset of these elements, or may include different components altogether.

Although the above description has focused on an example in which the control device is applied to an inkjet printer that ejects ink from nozzles onto a recording sheet S, the present disclosure is not limited to this configuration. The control device may instead be used in a laser printer having replaceable components such as toner cartridges and paper transport rollers. Furthermore, the control device may be applied to electronic apparatuses other than recording devices, such as scanners equipped with replaceable components like light source units.

The processing flows illustrated in FIGS. 6 and 7 are configured to control various screen displays based on the results of component and main-body diagnostics. From another perspective, however, they are characterized by their ability to guide user behavior in a proactive manner through the coordination of replacement timing and warranty information. That is, for example, when the remaining service life of a replaceable component or the main body of the printer becomes short, the system can prompt the user to renew or extend the warranty or guide them to initiate replacement, depending on the warranty status. This enables such replacement or other actions to be carried out while the warranty remains valid. This processing not only displays diagnostic results but, in combination with warranty information, provides substantive user support and contributes to the optimization of device maintenance and operation. It constitutes one of the key advantages of the present disclosure. The processing flows shown in FIGS. 6 and 7 will now be described in further detail.

In the process based on the flowchart shown in FIG. 6, the controller 80 first performs a diagnostic process to evaluate the remaining service life of a replaceable component (S201). If the remaining service life is found to be less than a first threshold period (S202: YES), subsequent branching logic is executed. Specifically, based on whether the warranty period of the first warranty contract has been entered (S203), the process proceeds accordingly. If no input has been made (S203: NO), the controller checks whether a second warranty contract has been concluded (S205). If not (S205: NO), the fourth contract guidance screen display process (S206) is executed; if concluded (S205: YES), the first warranty notification screen display process (S207) is executed. If the first warranty period has been entered (S203: YES), the controller checks whether it has expired (S204). If expired (S204: YES), the process branches in the same manner according to the result of S205. If the warranty is still valid (S204: NO), the controller determines whether the second warranty contract has been concluded (S208). If not, the second warranty notification screen display process (S209) is executed; if concluded, the third warranty notification screen display process (S210) is executed. As such, the system implements adaptive guidance control based on diagnostic results, warranty information, and contract status.

In the process based on the flowchart shown in FIG. 7, the controller 80 performs a diagnostic process to assess the remaining service life of the printer main body (S301). If the remaining service life is less than a second threshold period (S302: YES), the process continues with branching logic similar to that of FIG. 6. Specifically, based on whether the warranty period of the first warranty contract has been entered (S303), whether it has expired (S304), and whether the second warranty contract has been concluded (S305), one of the screen display processes S306 through S310 is executed. If no input has been made or the warranty period has expired, and the second warranty contract has not been concluded, the fourth contract guidance screen display process (S306) is executed. If the contract has been concluded, the first warranty notification screen display process (S307) is executed. If the warranty is still valid (S304: NO), the process further branches depending on the second warranty contract status: if not concluded, the second warranty notification screen display process (S309) is executed; if concluded, the third warranty notification screen display process (S310) is executed. In this manner, appropriate guidance based on the diagnostic result and warranty status is also provided for the main body, not just the components.

In the control device of the present embodiment, the system is configured to execute various notification and guidance processes based on a combination of service life information obtained from diagnostic processing and warranty period information obtained from warranty contracts. The significance of each process shown in FIGS. 6 and 7-namely, S206, S207, S209, S210, S306, S307, S309, and S310-is detailed below.

The fourth contract guidance screen display processes (S206, S306) are executed when the service life of a replaceable component or the printer main body is nearing its end, the first warranty contract has expired, and the second warranty contract has not been concluded. These processes serve to notify the user in advance that the replacement timing may fall outside the scope of warranty coverage and to encourage the user to conclude the second warranty contract to maintain coverage. This configuration, which prompts the user to renew the contract in advance of the actual need for replacement, provides preventive benefits to the user and enhances the planning and efficiency of maintenance operations on the manufacturer's side.

The first warranty notification screen display processes (S207, S307) are executed when the diagnostic result indicates that the end of service life is imminent, the first warranty contract has already expired, and the second warranty contract has been concluded. In such a situation, where the replacement timing is outside the first warranty period but coverage under the second warranty contract is available, the system clearly informs the user that the replacement is covered. This prevents the user from overlooking available warranty coverage and enhances the reliability and effectiveness of support services.

The second warranty notification screen display processes (S209, S309) are executed when the diagnostic result indicates that the end of service life is approaching, the first warranty period remains valid, and the second warranty contract has not been concluded. These processes inform the user that replacement may be covered under the first warranty contract and encourage timely response. By doing so, the system helps prevent situations where replacements occur outside warranty coverage, contributing to both improved user benefit and overall service quality.

The third warranty notification screen display processes (S210, S310) are executed when the diagnostic result indicates that the remaining service life is short, the first warranty contract is still valid, and the second warranty contract has already been concluded. These processes notify the user that the replacement is covered under the second warranty contract and may also indicate the possibility of coverage under the first warranty contract, depending on the circumstances. This ensures that the user is fully aware of the available coverage options and enables them to make informed decisions with sufficient time, thereby contributing to increased trust in the warranty system.

According to the above aspects of the present disclosure, there is disclosed a control device including an input unit configured to allow a user to input information, a display unit, a storage unit, a replaceable component, and a controller. The controller is configured to obtain a warranty expiration date associated with the replaceable component, evaluate a remaining service life of the replaceable component through a diagnostic process, and cause the display unit to display different information related to replacement of the replaceable component, depending on a relationship between the warranty expiration date and the remaining service life.

What is claimed is:

1. A consumable component consuming device, comprising:
an input unit configured to receive user input;
a display unit;
a storage unit; and
a controller configured to:
cause the display unit to display an input screen that prompts a user to input a warranty period associated with a first warranty contract via the input unit; and
store, in the storage unit, warranty period information corresponding to the warranty period of the first warranty contract based on input received via the input unit.

2. The control device according to claim 1,
wherein the controller is further configured to cause the display unit to display a first contract guidance screen that prompts the user to enter into a second warranty contract different from the first warranty contract in a case where no input regarding the warranty period of the first warranty contract has been received via the input unit.

3. The control device according to claim 2,
wherein the controller is further configured to:
obtain contract information indicating whether the user has concluded the second warranty contract; and
in a case where no input regarding the warranty period of the first warranty contract has been received via the input unit:
cause the display unit to display the first contract guidance screen when the contract information indicates that the second warranty contract has not been concluded; and
refrain from displaying the first contract guidance screen when the contract information indicates that the second warranty contract has been concluded.

4. The control device according to claim 1,
wherein, when input regarding the warranty period of the first warranty contract has been received via the input unit, and the warranty period information indicates that the warranty period of the first warranty contract has expired, the controller is configured to cause the display unit to display a second contract guidance screen that prompts the user to conclude a second warranty contract, which is different from the first warranty contract.

5. The control device according to claim 4,
wherein the controller is configured to obtain contract information indicating whether the user has concluded the second warranty contract, and
wherein, when input regarding the warranty period of the first warranty contract has been received via the input unit and the warranty period information indicates that the warranty period of the first warranty contract has expired, the controller is configured to:
if the contract information indicates that the second warranty contract has not been concluded, cause the display unit to display the second contract guidance screen; and
if the contract information indicates that the second warranty contract has been concluded, not cause the display unit to display the second contract guidance screen.

6. The control device according to claim 1,
wherein the controller is configured to:
obtain contract information indicating whether a second warranty contract, different from the first warranty contract, has been concluded by the user; and
when input regarding the warranty period of the first warranty contract has been received via the input unit, the warranty period indicated by the warranty period information has not expired, and a remaining period of the warranty period is less than a predetermined threshold period:
if the contract information indicates that the second warranty contract has not been concluded, cause the display unit to display a third contract guidance screen prompting the user to conclude the second warranty contract; and
if the contract information indicates that the second warranty contract has been concluded, refrain from displaying the third contract guidance screen.

7. The control device according to claim 6,
wherein, when the input regarding the warranty period of the first warranty contract has been received via the input unit, the warranty period indicated by the warranty period information has not expired, and a remaining period of the warranty period indicated by the warranty period information is equal to or greater than the particular remaining threshold period, the controller is configured not to cause the display unit to display the third contract guidance screen regardless of whether the contract information indicates that the second warranty contract has been concluded.

8. The control device according to claim 1,
wherein the controller is configured to:
obtain contract information indicating whether a second warranty contract, which is different from the first warranty contract, has been concluded by the user;
perform a diagnostic process to evaluate either a remaining service life of a user-replaceable component included in the control device, or a remaining service life of a main body of the control device; and
when the diagnostic result indicates that the remaining service life of the user-replaceable component is less than a first threshold period, or the remaining service life of the main body is less than a second threshold period, and when:
(i) either the warranty period of the first warranty contract has not been input via the input unit, or the warranty period has been input and the warranty period information indicates that the warranty period has expired; and
(ii) the contract information indicates that the second warranty contract has not been concluded,
cause the display unit to display a fourth contract guidance screen that prompts the user to conclude the second warranty contract.

9. The control device according to claim 1,
wherein the controller is configured to:
obtain contract information indicating whether a second warranty contract, which is different from the first warranty contract, has been concluded by the user;
perform a diagnostic process to evaluate either a remaining service life of a user-replaceable component included in the control device, or a remaining service life of a main body of the control device; and
when the diagnostic result indicates that the remaining service life of the user-replaceable component is less than a first threshold period, or the remaining service life of the main body is less than a second threshold period, and when:
(i) either the warranty period of the first warranty contract has not been input via the input unit, or the warranty period has been input and the warranty period information indicates that the warranty period has expired; and
(ii) the contract information indicates that the second warranty contract has been concluded,
cause the display unit to display a first warranty notification screen that informs the user that the user-replaceable component or the main body of the control device is covered under the second warranty contract.

10. The control device according to claim 1,
wherein the controller is configured to:
obtain contract information indicating whether a second warranty contract, which is different from the first warranty contract, has been concluded by the user;
perform a diagnostic process to evaluate either a remaining service life of a user-replaceable component included in the control device, or a remaining service life of a main body of the control device; and
when the diagnostic result indicates that the remaining service life of the user-replaceable component is less than a first threshold period, or the remaining service life of the main body is less than a second threshold period, and when:
(i) the warranty period of the first warranty contract has been input via the input unit, and the warranty period information indicates that the warranty period has not expired; and
(ii) the contract information indicates that the second warranty contract has not been concluded,
cause the display unit to display a second warranty notification screen that informs the user that the user-replaceable component or the main body of the control device is covered under the warranty during the warranty period of the first warranty contract.

11. The control device according to claim 1,
wherein the controller is configured to:
obtain contract information indicating whether a second warranty contract, which is different from the first warranty contract, has been concluded by the user;
perform a diagnostic process to evaluate either a remaining service life of a user-replaceable component included in the control device, or a remaining service life of a main body of the control device; and
when the diagnostic result indicates that the remaining service life of the user-replaceable component is less than a first threshold period, or the remaining service life of the main body is less than a second threshold period, and when:
(i) the warranty period of the first warranty contract has been input via the input unit, and the warranty period information indicates that the warranty period has not expired; and
(ii) the contract information indicates that the second warranty contract has been concluded,
cause the display unit to display a third warranty notification screen that informs the user that the user-replaceable component or the main body of the control device is covered under the second warranty contract.

12. The control device according to claim 1,
further comprising a user-replaceable component,
wherein the controller is configured to:
obtain contract information indicating whether a second warranty contract, which is different from the first warranty contract, has been concluded by the user;
perform, at a predetermined timing, a normal component diagnosis to evaluate a remaining service life of the user-replaceable component;
when the warranty period of the first warranty contract has been input via the input unit, and the warranty period information indicates that the warranty period has not expired and that a remaining period of the warranty period is less than a predetermined remaining period, and the contract information indicates that the second warranty contract has not been concluded,
perform a special component diagnosis, different from the normal component diagnosis, to evaluate the remaining service life of the user-replaceable component;
when a result of the normal component diagnosis indicates that the remaining service life of the user-replaceable component is less than a third threshold period, cause the display unit to display a first service life notification screen that notifies that the remaining service life of the user-replaceable component is short; and
when a result of the special component diagnosis indicates that the remaining service life of the user-replaceable component is equal to or greater than the third threshold period and less than a fourth threshold period, cause the display unit to display the first service life notification screen.

13. The control device according to claim 1,
wherein the controller is configured to:
obtain contract information indicating whether a second warranty contract, which is different from the first warranty contract, has been concluded by the user;
perform, at a predetermined timing, a normal body diagnosis to evaluate a remaining service life of a main body of the control device;
when the warranty period of the first warranty contract has been input via the input unit, and the warranty period information indicates that the warranty period has not expired and that a remaining period of the warranty period is less than a predetermined remaining period, and the contract information indicates that the second warranty contract has not been concluded,
perform a special body diagnosis, different from the normal body diagnosis, to evaluate the remaining service life of the main body;
when a result of the normal body diagnosis indicates that the remaining service life of the main body is less than a fifth threshold period, cause the display unit to display a second service life notification screen that notifies that the remaining service life of the main body is short; and
when a result of the special body diagnosis indicates that the remaining service life of the main body is equal to or greater than the fifth threshold period and less than a sixth threshold period, cause the display unit to display the second service life notification screen.

14. The control device according to claim 2,
wherein the second warranty contract is a subscription contract under which warranty coverage is continued by payment of a predetermined fee at predetermined intervals.
